(19) United States
(12) Patent Application Publication
(10) Pub. No.: US 2014/0050821 A1
(43) Pub. Date: Feb. 20, 2014

(54) STRIPED FLATBREAD FOOD PRODUCT AND METHODS OF PREPARATION

(71) Applicants: Russell Alan Meigs, Clovis, CA (US); Alex Jeffrey Tangonan, Dinuba, CA (US)

(72) Inventors: Russell Alan Meigs, Clovis, CA (US); Alex Jeffrey Tangonan, Dinuba, CA (US)

(73) Assignee: Ruiz Food Products, Inc., Dinuba, CA (US)

(21) Appl. No.: 13/837,468

(22) Filed: Mar. 15, 2013

Related U.S. Application Data
(60) Provisional application No. 61/683,644, filed on Aug. 15, 2012.

(51) Int. Cl. A21D 13/00

(52) U.S. Cl. CPC A21D 13/00
USPC 426/94; 426/560; 426/250

(57) ABSTRACT

A flatbread including a planar base portion formed from a first dough material and at least one stripe or band formed on the planar base portion. The stripe or band may be formed from a second dough material having one of a color or a flavor different from the first dough material. A method of producing a tortilla or flatbread including loading a first dough base material into a primary dough extruder and loading a second dough base material into an secondary dough extruder. The method further including ejecting the first dough base material from the primary dough extruder onto a conveyor belt in the form of a sheet of dough. The second dough base material is ejected from the secondary dough extruder and onto the sheet of dough in the form of bands and the bands are pressed into the sheet of dough to form a striped tortilla shell.

### CROSS-REFERENCE TO RELATED APPLICATION

This application claims priority from U.S. Provisional Patent Application Ser. No. 61/683,644, filed on Aug. 15, 2012.

### FIELD

A flatbread having a stripe or band and method for preparing the same; more specifically, a tortilla having a flavored and/or colored stripe or band. Other embodiments are also described and claimed.

### BACKGROUND

A flatbread is a type of bread product typically made with flour, water, and salt and then pressed into flattened dough. Many flatbreads are unleavened, meaning that they are made without yeast or sourdough culture. Some flatbreads, such as pita bread, however, may be made with yeast. A tortilla is a type of flatbread typically made with corn or flour as the primary ingredient. Although flatbreads and tortillas can come in a variety of colors and flavors, such colors and flavors are uniformly distributed through the dough prior to flattening. As such, flatbreads and tortillas appear as a single relatively uniform color, for example, yellow in the case of a corn tortilla or white in the case of a flour tortilla.

### SUMMARY

A flatbread product is disclosed herein which has a series of one or more bands of colored and/or flavored dough. The bands are formed such that they create the appearance of stripes across the flatbread. In embodiments where the bands are flavored, they also add to the overall flavor of the flatbread. The striped flatbread product may be made through an automated machine assembly, which allows for high speed manufacture of a die cut extruded flatbread or extruded product having stripes. Representatively, the automated process may allow for production of between about 2,500 dozen to about 8,200 dozen striped flatbread or tortilla units per hour.

The striped flatbread may be formed by a series of one or more extrusions of colored and/or flavored dough which are laid on top of a continuous extrusion of another color or flavor of dough on a die cut extrusion line. Representatively, in one embodiment, a co-extrusion process may be used to make the striped tortilla or flatbread. In this aspect, a base dough material may be prepared and extruded by a first extruder into a relatively flat sheet of dough. A colored and/or flavored dough may be prepared and extruded by a second extruder above the first extruder. The second extruder may include a multi-port outlet depositor to help deposit the dough on the extruded base dough material in the form of continuous beads, ropes or bands. The base dough extrusion and the colored and/or flavored dough extrusion travel in the same direction such that the colored and/or flavored dough can be deposited along the base dough extrusion. The dough combination is then automatically transferred through a reducing roller assembly which presses the colored and/or flavored bead of dough into the base dough sheet to create a striped dough sheet having stripes on the surface. The striped dough sheet is then directed toward a die cutting wheel which cuts the sheet into units of the desired shape to create a flatbread and/or tortilla product.

### BRIEF DESCRIPTION OF THE DRAWINGS

The following illustration is by way of example and not by way of limitation in the figures of the accompanying drawings in which like references indicate like elements. It should be noted that references to “an” or “one” embodiment in this disclosure are not necessarily to the same embodiment, and such references mean at least one.

FIG. 1A illustrates a front plan view of one embodiment of a flatbread.

FIG. 1B illustrates a back plan view of the flatbread of FIG. 1A.

FIG. 1C illustrates a cross-sectional view of the flatbread of FIG. 1A along line 1-1′.

FIG. 2A illustrates a perspective view of one embodiment of a flatbread wrapped around a filling.

FIG. 2B illustrates a cross-sectional view of the flatbread of FIG. 2A along line 2-2′.

FIG. 3 illustrates one embodiment of an automated system for making a striped food product.

FIG. 4 illustrates a perspective view of one embodiment of a processing step for producing a flatbread.

FIG. 5 illustrates a perspective view of one embodiment of a processing step for producing a flatbread.

FIG. 6 illustrates a perspective view of one embodiment of a processing step for producing a flatbread.

FIG. 7 illustrates a top perspective view of one embodiment of a processing step for producing a flatbread.

FIG. 8 illustrates one embodiment of a side view of a machine assembly for producing a flatbread.

### DETAILED DESCRIPTION

In this section we shall explain several preferred embodiments of this invention with reference to the appended drawings. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known structures and techniques have not been shown in detail so as not to obscure the understanding of this description.

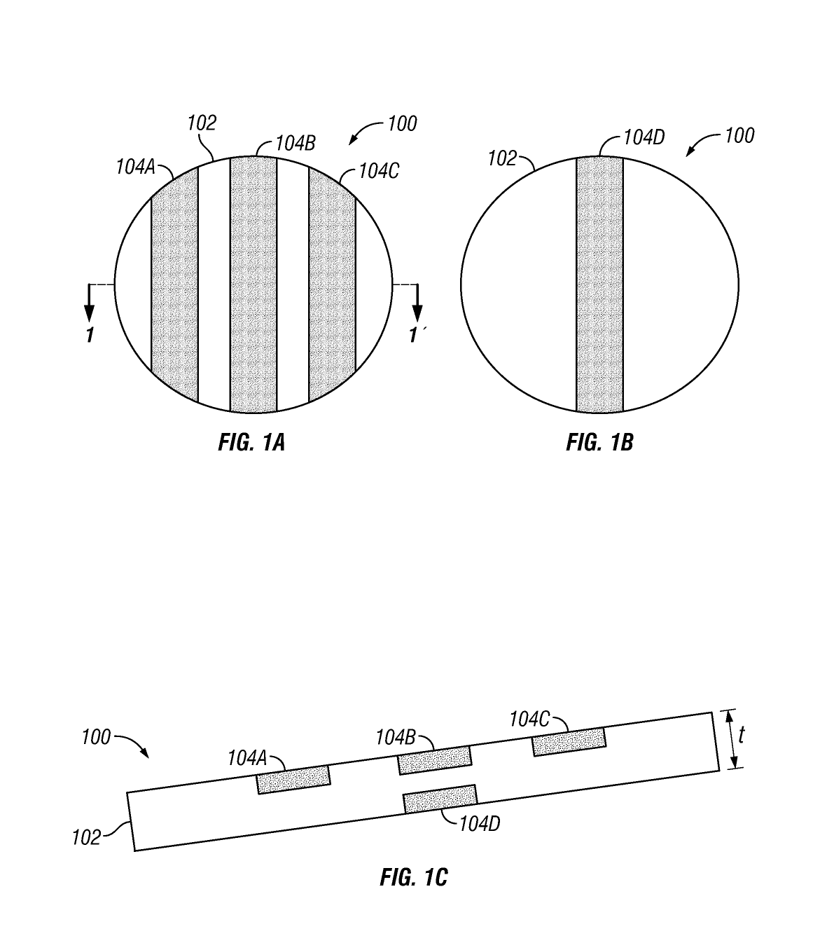

FIG. 1A illustrates a front plan view of one embodiment of a flatbread. FIG. 1B illustrates a back plan view of the flatbread of FIG. 1A. In one embodiment, the flatbread may be a tortilla 100. As previously discussed, a tortilla is a type of flatbread made with a flour and water based dough, that is pressed, cut and cooked to form a relatively pliable shell that can be wrapped or rolled around, for example, a filling, without breaking to form a wrapped or rolled food product. Tortilla 100 may include a substantially planar base portion 102 having one or more bands 104A, 104B, 104C and 104D formed thereon. Each of base portion 102 and bands 104A-104D may be formed of a dough material as will be described in more detail below, except that the dough material for bands 104A-104D may have a different characteristic than the dough material for base portion 102 such that it modifies an appearance of base portion 102. Representatively, in one embodiment, the dough material for bands 104A-104D may include a coloring or flavoring agent different than the dough of base portion 102 such that bands 104A-104D are a different color than base portion 102.

In some embodiments, one or more of bands 104A-104D may be formed by discrete pieces of dough positioned across base portion 102 to create the appearance of stripes across tortilla 100. Bands 104A-104D may, in some embodiments, be oriented parallel to one another across base portion 102 as illustrated in FIGS. 1A-1B. In other embodiments, one or more of bands 104A-104D may be oriented in any manner across base portion 102 sufficient to produce a tortilla having a multi-colored appearance. For example, one or more of bands 104A-104D may have a wavy design or they may cross one another to form, for example, a crisscross pattern.

In some embodiments, bands 104A-104D may be formed on both the front side of base portion 102 as illustrated in FIG. 1A and the back side of base portion 102 as illustrated in FIG. 1B. For example, in one embodiment, three bands 104A-104C may be formed on the front side of base portion 102 and one band 104D may be formed on the back side of base portion 102. It is contemplated, however, that any number of bands 104A-104D may be formed on the front and back sides of base portion 102. Alternatively, bands 104A-104D may be formed on only the front or only the back side of base portion 102. One or more of bands 104A-104D may extend across an entire diameter of base portion 102 as illustrated in FIGS. 1A-1B. Alternatively, one or more of bands 104A-104D may extend across only a portion of base portion 102. In addition, although bands 104A-104D having substantially the same width are illustrated, it is contemplated that bands 104A-104D may have different widths.

FIG. 1C illustrates a cross-sectional view of the tortilla or flatbread of Figure lA along line 1-1′. From this view, it can be seen that in one embodiment, bands 104A-104D may be integrated within the base dough material of base portion 102 such that it does not extend through an entire thickness (t) of base portion 102. Rather, bands 104A-104D are confined to a surface area of base portion 102. In this way, the amount of the flavor components required to significantly impact the overall flavor of the final product is minimized. In particular, by placing the aromas and flavors on the surface of base portion 102 rather than homogenously distributing them throughout the mass of base portion 102, the palate first senses the surface of tortilla 100. In this aspect, a more pronounced flavor and aroma is experienced than when the same amount of flavor components are uniformly distributed throughout the product. As an example, bands 104A-104B could be flavored with tomato or basil to identify that the food in the product is an “Italian style” such as a pizza filling.

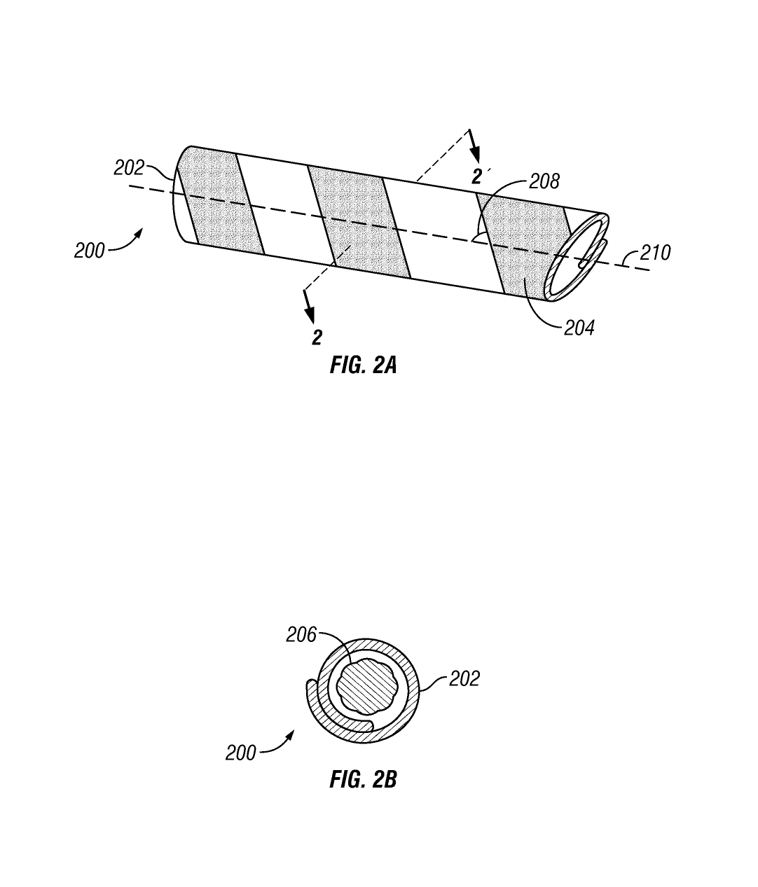

Tortilla 100 having one or more bands 104A-104D formed thereon may be wrapped or rolled around a filling to form an edible food product as illustrated in FIG. 2A and FIG. 2B. FIG. 2A illustrates a side perspective view of a tortilla wrapped around a filling to form a rolled food product. FIG. 2B illustrates a cross-sectional view of the food product of FIG. 2A along line 2-2′. In some embodiments, the food product may be a taquito 200. It is contemplated, however, that the food product may be any other type of edible food product made from a flatbread such as a tortilla, for example, a taco, a burrito, a chimichanga, a gyro or a wrap. Taquito 200 may be formed by rolling a tortilla, such as that previously described, around a filling 206 and then frying it to form a fried food product. Taquito 200 may have an elongated shape as defined by longitudinal axis 210.

In one embodiment, the tortilla base portion 202 having bands 204 formed therein, as previously discussed, may be wrapped around filling 206 such that at least one of the bands 204 forms an angle 208 with respect to the longitudinal axis 210. Representatively, in one embodiment, bands 204 may be diagonally oriented with respect to longitudinal axis 210 such that taquito 200 has a distinctive “barber pole” type appearance that allows it to be distinguished from other tortilla or flatbread products. Alternatively, bands 204 may be oriented in other directions to give the food product a distinctive appearance, for example, lengthwise along the food product or orthogonal to longitudinal axis 210.

Different filling and tortilla and/or flatbread flavor combinations for taquito 200 are contemplated. Representative flavor combinations may include, but are not limited to, a flour or corn dough base with bands having a southwest, chipotle, tomato, basil, red chili, buttermilk and/or green chili flavor. Suitable fillings may include, but are not limited to, cheese, chicken, beef, pepperoni, sausage, egg, steak and/or potato.

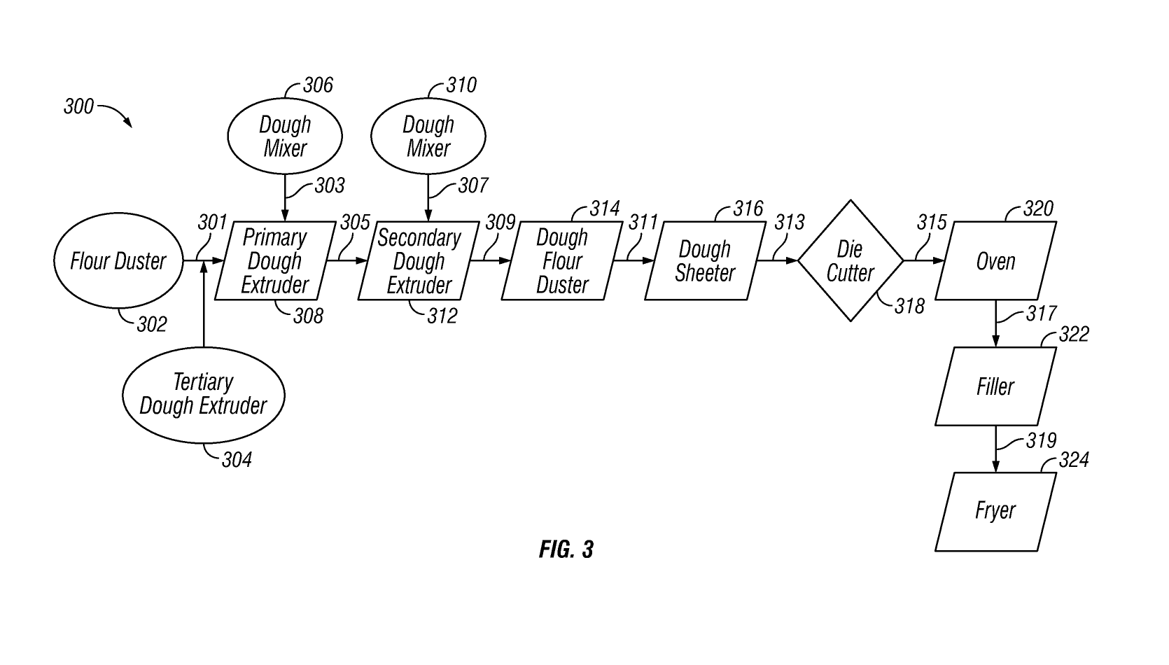

FIG. 3 illustrates one embodiment of an automated system for making a striped food product. In FIG. 3, material pathways are illustrated with arrows. As used herein, “material” refers to any dough based material used to make a striped food product as described herein. In the illustrated examples, the material pathways represent examples of transport paths that may be traveled by the dough throughout the machine assembly. A typical progression of the dough from one station or system component to the next is depicted by the direction of the arrow. However, it should be understood that the processing stations are provided as examples, as are the directions of material flow. It shall be appreciated that more, fewer or other processing stations may be used in practice of the present invention, and/or more, fewer or other material paths and directions may be used in the practice of the present invention. In addition, the stations may be in any order and any orientation (e.g., vertically stacked or side by side).

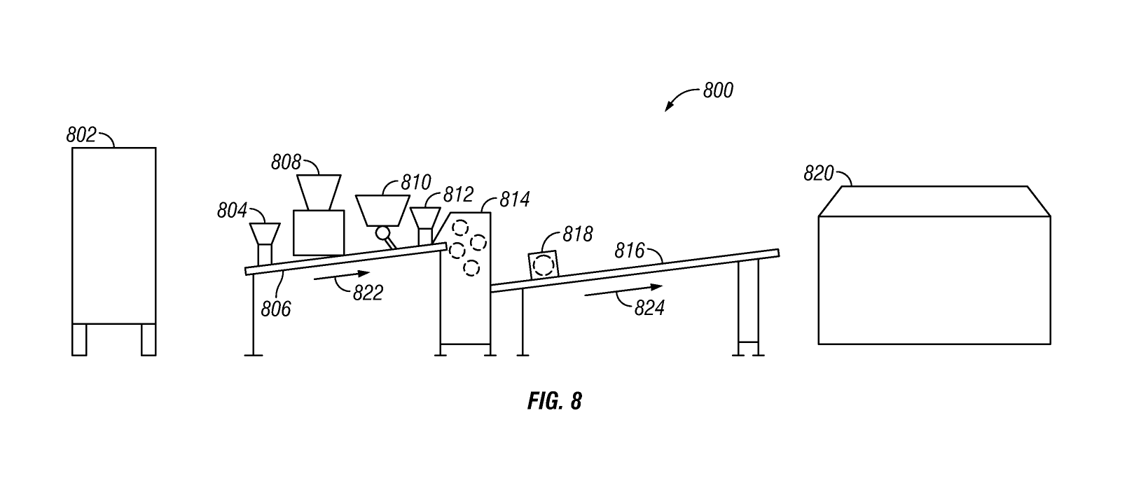

Any form of transport may be used that is sufficient to automatically transport the dough as indicated by the material pathways. For example, material may be transported by a robotic device such as a conveyor from one station to the next, as will be discussed in more detail in reference to FIG. 8. Alternatively, one or more of the material pathways may be a manual pathway along which the dough can be transported manually by, for example, a technician along the assembly line.

In one embodiment, process 300 is a co-extrusion process used to make a striped food product such as a striped tortilla. Process 300 may include forming a first base dough in dough mixer 306 and forming a second banding dough in a separate dough mixer 310. The first base dough may be used to form the base portion of the tortilla while the second banding dough may be used to form the stripes or bands on the base portion. The first base dough and the second banding dough may have a consistency sufficient to allow for processing according to the co-extrusion process disclosed herein and may be formed using any process and ingredients suitable for forming a flatbread or tortilla dough.

For example, in one embodiment, the first base dough and the second banding dough may be made by mixing wheat flour, water, lard and salt in dough mixers 306 and 310. In some embodiments, however, in order to produce a striped tortilla product using the high speed automated line described herein, more complex formulations may be required to maintain process efficiency. For example, the first base dough and the second banding dough may be made with a high protein flour such as hard red wheat flour, white winter wheat flour or spring wheat flour. These wheat flours are collectively referred to as bread flour. Such bread flours are desired for the process described herein because they have a protein content of 10 to 12%. Low protein or poor protein quality leads to tortillas which easily crack or crumble when folded and have short shelf life. In some embodiments, the first base dough and/or the second banding dough may include bread flour in an amount of up to 100 percent by weight of the entire dough composition.

Water may further be included in the dough in an amount of from about 46 percent to about 56 percent, for example 52 percent by weigh of the entire dough composition.

In addition to bread flour and water, variable amounts of shortening or oil, salt, leavening agents, coloring and/or flavoring agents and small amounts of other ingredients may further be included in the first base dough and/or the second banding dough. The first base dough and/or the second banding dough may further include conditioners, emulsifiers and/or reducing agents in higher amounts than that found in other bread types. These additives play an important role in the dough processing quality. In particular, they can help to improve machinability, shelf life and reduce stickiness.

Representative conditioning and/or emulsifying agents may include, but are not limited to, mono and diglycerides in amounts of from about 0 percent to about 1.0 percent, for example, 0.2 percent by weight of the total dough composition, or sodium stearoyl lactylate in an amount of from about 0 percent to about 0.5 percent, for example, about 0.2 percent by weight of the total dough composition.

Representative reducing agents may include, but are not limited to, sodium metabisulfite and L-Cysteine. The reducing agents may be included in an amount of from about 0 ppm to about 90 ppm, or about 20 ppm or 30 ppm.

Sorbic acid may also be included in the first base dough and/or the second banding dough to condition any gluten therein and improve machinability. Representatively, sorbic acid may be included in an amount of from about 0 percent to about 1 percent, or about 0.5 percent by weight of the total dough composition.

In addition, in some embodiments, the dough may include leavening agents to expand the dough during the baking process. This expansion, which occurs due to release of gas during the heat of baking, lightens the texture of the crust, tenderizing it and lightening the crust color to produce a more desirable eating texture. Representative leavening agents may include, but are not limited to, baking powder or yeast. The leavening agents may be included in an amount of from about 0 percent to about 6 percent, for example, from about 1 percent to about 3 percent by weight of the total dough composition.

Fats in the form of oil or shortening may also be included in the dough to improve the extensibility of the dough, which in turn allows the tortilla or flatbread product to be produced by the high speed machine line described herein. In particular, flatbread and/or tortillas made with higher fat content generally are less likely to crack or break when folded. The fats may be included in an amount of from about 6 percent to about 12 percent, for example, about 8 percent by weight of the total dough composition.

In some embodiments, salt may be added to the dough in an amount of from about 0.5 percent to about 2.5 percent, or about 0.75 percent by weight of the total dough composition for flavor and to increase the strength of the wheat gluten.

It is further to be understood that in the case of the second banding dough, an additive such as a flavoring or coloring agent is further included. The colored and/or flavored dough may be the same as the base dough material except that a coloring or flavoring agent is added to give it a desired color or flavor. Representatively, where it is desirable for the second banding dough to have a different flavor from the base dough, additional flavoring agents may be added. Exemplary flavoring agents may include, but are not limited to, agents having a southwest, chipotle, tomato, basil, red chili, buttermilk and/or green chili flavor. In addition, a coloring agent such as food coloring may be added to the colored and/or flavored dough to give it a color different from the base dough. Representative coloring agents may include a green, red, yellow, orange, brown or any other coloring agent suitable for achieving a desired color may be used.

The flavoring or coloring agent may be included in any amount sufficient to modify a color and/or flavor of the second banding dough so that it is different in appearance from the first base dough. Representatively, in one embodiment, the flavoring or coloring agent is included in an amount of from about 5 percent to about 20 percent, for example 10 percent, of the flour amount included in the formulation.

A representative formulation for one embodiment of a first base dough and/or a second banding dough is illustrated by Formulation I below. The ingredient amounts are in weight percent of the total dough composition expect where otherwise indicated.

Formulation I

| Ingredient | Amount |
|---|---|
| Bread Flour | Up to 100 |
| Water | 46-56 |
| Shortening or oil | 6-12 |
| Salt | 0.50-2.50 |
| Sodium Stearoyl Lactylate | 0-0.50 |
| Sodium Metabisulfite | 0-90 ppm |
| Mono and Diglycerides | 0-1.0 |
| Sorbic Acid | 0-1.0 |
| L-Cysteine | 0-90 ppm |
| Baking Powder | 0-3 |
| Yeast | 0-3 |

It is further to be understood that in embodiments where Formulation I is used to form the second banding dough, an additive such as a flavoring or coloring agent is further included as previously discussed.

In order for the dough material to be used with the die cut machine line described herein, the first base dough and the second banding dough should be mixed by dough mixers 306, 310 until well developed, soft, dry and extensible. A properly mixed dough should be capable of being easily stretched into a long thin rope between the hands with little effort. This dough condition permits the dough to flow through the extruders without blockage or bridging. The low degree of resistance to shaping is a critical characteristic of the correctly developed tortilla or flatbread dough condition. In this aspect, it is to be understood that the characteristics of the tortilla and/or flatbread doughs described herein are different from that of other types of less elastic doughs having a different consistency (e.g., pasta doughs), which would not be fluid or sticky enough to be extruded and combined with one another to form a striped product as described herein. For example, a pasta type dough, which is typically made from durham wheat, is a relatively dry, granular dough which is not suitable for use in the extrusion process described herein because the process requires a relatively extensible dough which can flow through the extruders and bond to, in the case of the colored and/or flavored dough, a base dough sheet.

In addition, die cut systems stress the dough during the extruding and sheeting process. Because of this high degree of stress, special qualities or characteristics of the dough are required for the process to function consistently. In particular, the dough condition required for the die cut process has a remarkable degree of extensibility so that it can be quickly reduced in thickness without tearing. This dough condition also ensures that the cut dough pieces are uniform in shape after baking If the dough condition is too dry or tough, as may be the case with a durham wheat dough (e.g., a pasta dough), the dough may resist the rapid reduction in thickness. When this resistance is significant, a condition occurs known as “memory”. In such cases the gluten proteins are stretched excessively and then recoil after sheeting and during baking This results in tortillas which are tough, brittle and dry. In addition, they tend to have an oval shape due to the proteins recoiling back to their original shape.

The previously discussed dough condition also directly impacts the functionality of the tortilla and flatbread during the assembly process when the product is rolled or folded into a shape. Tortillas made from doughs which are too tough or dry or stressed will attempt to recover to their previous shape. This condition manifests itself in products which unroll or spring back after assembly. To control this condition, it is necessary to carefully select the quality of the flour used in the formulation. For example, to make a striped tortilla product, the dough should be made from a hard wheat flour such as any of those previously discussed. In addition, the use of dough conditioners in the correct amounts and types play an important role in the dough's functionality.

Once the doughs are mixed by dough mixer 306 and dough mixer 310, the doughs travel down material pathway 303 and material pathway 307, respectively, to their respective dough extruders 308 and 312, respectively. In some embodiments, prior to extruding the doughs from dough extruders 308 and 312, flour duster 302 applies flour along material pathway 301 such that the bottom side of any dough extruded thereon (from dough extruder 308) is floured to, for example, prevent the dough from sticking to the material pathway. Primary dough extruder 308 is an extrusion die capable of extruding the dough into a flat sheet of dough. Representatively, primary dough extruder 308 may include rollers which compress the dough received from dough mixer 306 and roll the dough out onto material pathway 305 (e.g., a conveyor) in the form of a flat sheet of dough. Material pathway 305 then advances the sheet of dough to secondary extruder 312. In some embodiments, primary dough extruder 308 may continuously extrude a sheet of dough such that a continuous sheet of dough travels along the various material pathways associated with process 300.

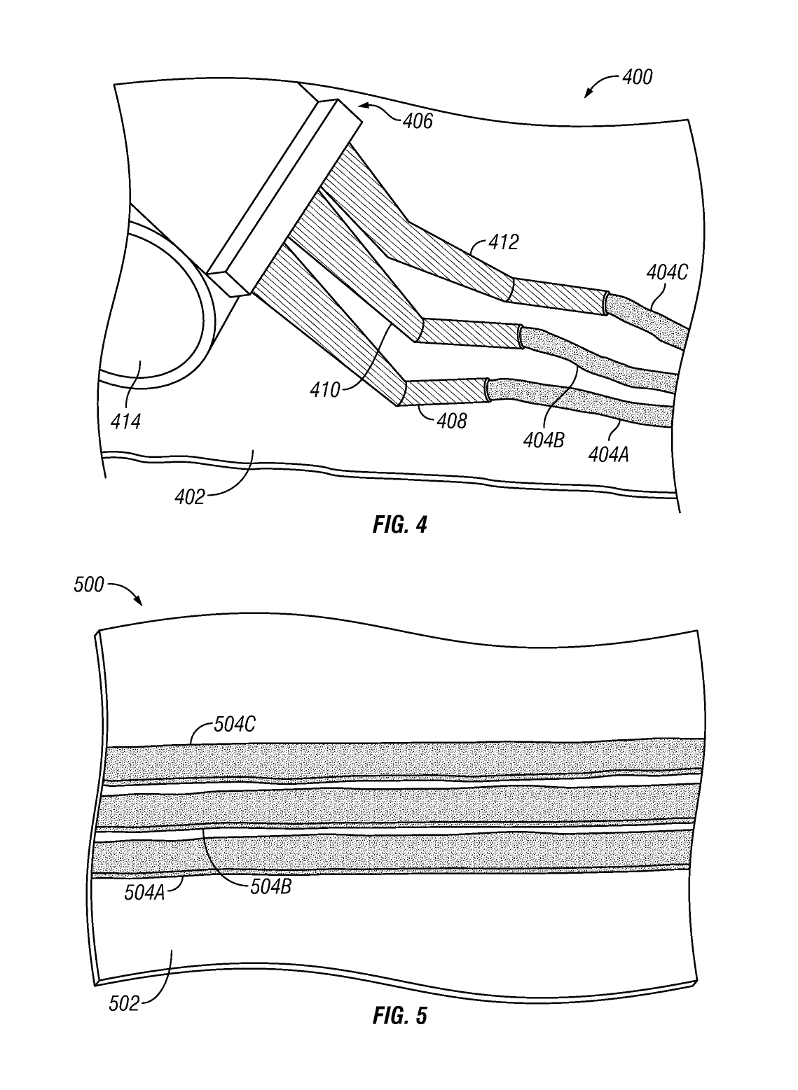

Secondary dough extruder 312 is downstream from primary dough extruder 308 and positioned above primary dough extruder 308 such that dough extruded from secondary dough extruder 312 is applied to a top side of the sheet of dough as it is drawn below secondary dough extruder 312 by the material pathway. In some embodiments, secondary dough extruder 312 is configured to extrude bands or ropes of dough on top of the sheet of dough as illustrated in more detail in reference to FIG. 4 and FIG. 5. The bands of dough may have a characteristic different from the sheet of dough. Representatively, the bands of dough may be formed from a secondary banding dough having a coloring or flavoring different from the base dough used to form the sheet of dough.

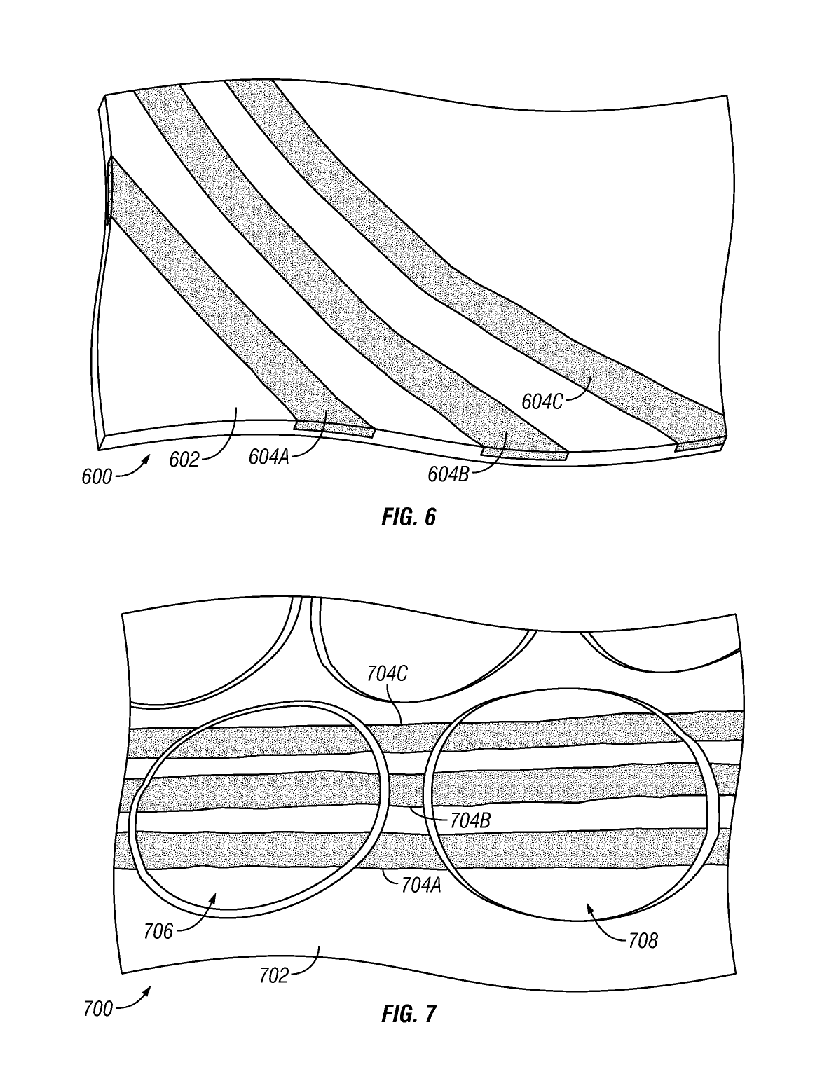

Once the bands of dough are applied to the underlying sheet of dough, the sheet of dough having the bands thereon advances along material pathway 309 to flour duster 314 which applies a dusting of flour to the top surface of the dough. The dough then continues along material pathway 311 to dough sheeter 316. Dough sheeter 316 may be a reducing roller assembly which presses the bands of dough into the sheet of dough to form a substantially planar striped sheet of dough as illustrated in FIG. 6. In some embodiments, dough sheeter 316 is configured to press the bands only partially into the sheet of dough such that they do not extend through an entire thickness of the sheet of dough as previously discussed. Dough sheeter 316 may also reduce the overall thickness of the striped sheet of dough to that which is suitable for processing by the remaining stations.

Once the striped sheet of dough has been reduced to the correct thickness for the product being made (e.g., a tortilla), the striped sheet of dough is advanced along material pathway 313 to die cutter 318. Die cutter 318 may be any type of cutting mechanism capable of cutting the striped sheet of dough into a size and shape desired for the final food product (e.g., a striped tortilla). This operation will be described in more detail in reference to FIG. 7. The cut dough continues along material pathway 315 to oven 320. Oven 320 may be any type of oven suitable for cooking a dough based food product.

The cooked food product is then removed from oven 320 and is used as the final product, or, in some embodiments, continues on for further processing. For example, in some embodiments, the cooked food product is a striped tortilla. The striped tortilla continues on along material pathway 317 to a filler station 322. At the filler station 322, a filling (e.g., meat, cheese, beans, etc.) is placed on the striped tortilla and then the striped tortilla is rolled around the filling. The filler station 322 may be an automated station in which a machine fills and rolls the tortilla or a manual station in which the steps are performed by a technician. In some embodiments, the filled and rolled striped tortilla then advances along material pathway 319 to a fryer 324. Fryer 324 may be any type of machine capable of frying a filled tortilla to form, for example, a taquito or other fried food product.

It is to be understood that the orientation of the tortillas or flatbread at the exit of oven 320 can be controlled so that the stripes on a final food product such as a taquito have the desired orientation. For example, the cut striped tortilla shells may be transported to filler station 322 with a particular orientation so that the stripes appear in the desired orientation (e.g., diagonal) on the final rolled product.

Process 300 may further include the optional step of applying stripes to a bottom side of the sheet of dough such that the final food product includes stripes on both sides. In this aspect, process 300 may include a tertiary dough extruder 304. Tertiary dough extruder 304 may be similar to the secondary dough extruder 312 in that it extrudes bands of dough except in this embodiment, it extrudes the bands onto a bottom side of the sheet of dough. Representatively, in some embodiments, tertiary dough extruder 304 may be positioned upstream from primary dough extruder 308. The tertiary dough extruder 304 extrudes bands of dough onto material pathway 301 (e.g., a conveyor) before the sheet of dough is extruded by primary dough extruder 308. The bands of dough are then advanced along material pathway 301 beneath the primary dough extruder 308 so that the primary dough extruder extrudes the sheet of dough onto the bands of dough. The sheet of dough having the bands on its bottom surface then advances along material pathway 305 to secondary dough extruder 312 for application of dough bands to the top surface and through the remaining stations as previously discussed. In this aspect, the final food product will include stripes on both sides.

FIG. 4 illustrates a perspective magnified view of one embodiment of a secondary dough extruder. From this view, it can be seen that secondary dough extruder 400 may be a multi-outlet extruder 406 having a manifold assembly 414 connected to a plurality of nozzles 408, 410, 412. The manifold assembly 414 may be mounted over the material pathway along which the sheet of dough 402 from the primary extruder travels such that nozzles 408-412 are positioned over the sheet of dough. Nozzles 408-412 are dimensioned to output dough bands 404A, 404B and 404C of the desired shape and size onto the underlying sheet of dough 402. Representatively, in one embodiment, nozzles 408-412 are tube like extensions capable of extruding cylindrical rope or bead like bands which, when pressed into the base dough sheet, can form defined stripes in the base dough material. Nozzles 408-412 may be adjustable such that their direction of output can be changed if desired. In the illustrated embodiment, nozzles 408-412 are positioned such that dough bands 404A-404C are output onto sheet of dough 402 in a parallel configuration. In addition, nozzles 402A-402C may be centered to a tortilla lane aligned with the die cutter in order to ensure each tortilla cut by the die cutter has the desired number of stripes. It is further to be understood that although three nozzles 404A-404C are illustrated, it is contemplated that any number of nozzles required to make the desired number of stripes may be used, for example, less than three, for example one nozzle, or more than three, for example, four nozzles. In addition, although extruder 400 is described as the secondary extruder, the previously discussed tertiary extruder may be substantially the same as the secondary extruder such that the description with respect to the secondary extruder also applies to the tertiary extruder.

FIG. 5 illustrates a perspective view of a sheet of dough having dough bands positioned thereon. From this view, it can be seen that the dough bands 504A, 504B and 504C applied by, for example a secondary extruder, onto the sheet of dough 502 are initially on top of the sheet of dough 502. Dough 500 is then advanced through a dough sheeter as previously discussed to compress bands 504A-504C into sheet of dough 502 and form the striped sheet of dough.

FIG. 6 illustrates a striped sheet of dough that can be output by a dough sheeter (e.g., dough sheeter 316). From this view, it can be seen that the striped sheet of dough 600 is a substantially planar sheet of dough which includes stripes 604A, 604B and 604C pressed into the base sheet of dough 602.

FIG. 7 illustrates an embodiment in which a striped sheet of dough is cut into tortillas by a die cutter. As can be seen from this view, striped sheet of dough 700 includes a sheet of dough 702 with stripes 704A, 704B and 704C formed thereon. The entire striped sheet of dough 700 is then advanced through a die cutter (e.g., die cutter 318) which cuts the tortillas 706 and 708 out of the striped sheet of dough 700 such that each tortilla 706 and 708 includes a plurality of stripes.

FIG. 8 illustrates a side view of one embodiment of a machine assembly for producing a flatbread. In one embodiment, machine assembly 800 may be an entirely automated system with automated machine stations capable of making a flatbread or flatbread product without manual intervention by a user. In this aspect, machine assembly 800 may be electronically connected to a controller (e.g. a computer) within which the user can input and/or select processing protocols for the machine assembly 800 to follow.

Machine assembly 800 may include a dough mixer 802 for mixing one of a primary base dough or a secondary banding dough and outputting the doughs to the proper extruder. Although only a single dough mixer 802 is shown in this view, it is contemplated that machine assembly 800 may include any number of dough mixers needed to properly mix a primary base dough and a secondary banding dough, and in some cases a third banding dough.

Machine assembly 800 may further include a supply conveyor 806 and a main conveyor 816 for advancing the doughs through the various stations of the machine assembly 800. In some embodiments, supply conveyor 806 and main conveyor 816 are conveyor belts that robotically move a dough positioned thereon in one continuous direction as illustrated by arrows 822 and 824 below each of the machine stations. Although conveyor belts are illustrated, it is contemplated that other types of robotic mechanisms capable of automatically advancing a sheet of dough without user intervention may be used to move the dough in one continuous sheet from one machine station to the next (e.g. a robotic arm).

Both the primary dough extruder 808 and the secondary dough extruder 810 may be positioned along supply conveyor 806, with primary dough extruder 808 being upstream from secondary dough extruder 810. Primary dough extruder 808 and secondary dough extruder 810 may be substantially similar to the primary and secondary dough extruder discussed in reference to FIGS. 3 and 4. In this aspect, a base sheet of dough output by primary dough extruder 808 passes continuously below secondary dough extruder 810 and the dough bands output by secondary dough extruder 810 can be continuously output along the base sheet of dough.

Flour dusters 804 and 812 may further be provided along supply conveyor 806 at positions upstream and downstream to extruders 808 and 810. Representatively, flour duster 804 may be positioned upstream from primary dough extruder 808 such that it applies a layer of flour to supply conveyor 806 prior to placing the sheet of dough on supply conveyor 806. Flour duster 812 may be positioned downstream from secondary dough extruder 810 such that it applies a layer of flour over the sheet of dough with the bands already applied thereto by the secondary dough extruder 810.

A dough sheeter 814 such as that previously described may be positioned downstream from secondary dough extruder 810 such that it receives the sheet of dough having the bands thereon. The sheet of dough with the bands thereon then passes through dough sheeter 814 where it is compressed to press the bands into the sheet of dough and form a striped dough sheet of the desired thickness.

The striped dough sheet can then be output by the dough sheeter 814 onto main conveyor 816. Main conveyor 816 advances the striped dough sheet to die cutter 818. Die cutter 818 may be substantially similar to the die cutter described in reference to FIG. 3. Die cutter 818 then cuts the striped dough sheet into units of the desired shapes and sizes (e.g., tortillas). The units are then advanced by main conveyor 816 to oven 820 where they are cooked to form the final food product. In embodiments where the final food product is a striped flatbread such as a striped tortilla, the processing is complete. In other embodiments, the final food product may include a flatbread with a filling. In such embodiments, machine assembly 800 may further include a filler machine and an optional fryer such that the striped flatbread can be filled with the filler food product and wrapped or rolled around the filler. In some cases, the rolled flatbread with the filler therein may further be fried in a fryer to, for example, form a taquito.

In the preceding detailed description, specific embodiments are described. It will, however, be evident that various modifications and changes may be made thereto without departing from the broader spirit and scope of the claims. For example, although a flatbread or tortilla shell product is disclosed, it is contemplated that the striped sheet of dough may be cut into other shapes and sizes to form other types of food products where a multicolored and/or striped appearance is desired. Representatively, the striped sheet of dough may be cut and then baked or fried using any of the previously discussed mechanisms to form tortilla chips, pita chips, crackers or the like having one or more color and/or flavor stripes integrated therein. The specification and drawings are, accordingly, to be regarded in an illustrative rather than restrictive sense.

What is claimed is:

1. A flatbread comprising:
a substantially planar base portion formed from a first dough material; and
at least one band formed on the base portion, the at least one band formed from a second dough material having one of a color or a flavor different from the first dough material.

2. The flatbread of claim 1 wherein the flatbread is a tortilla.

3. The flatbread of claim 1 wherein the substantially planar base portion having the at least one band formed thereon is pliable such that it is capable of bending without separating into different portions.

4. The flatbread of claim 1 wherein a first side of the planar base portion comprises a first band and a second side of the planar base portion comprises a second band.

5. The flatbread of claim 1 wherein a first side of the planar base portion comprises a different number of bands than a second side of the planar base portion.

6. The flatbread of claim 1 wherein at least three parallel bands are formed on at least one side of the planar base portion.

7. The flatbread of claim 1 wherein the at least one band does not extend through an entire thickness of the planar base portion.

8. The flatbread of claim 1 wherein the first dough material and the second dough material comprise a bread flour selected from the group consisting of hard red wheat flour, white winter wheat flour or spring wheat flour.

9. A flatbread food product comprising:
a striped shell wrapped around a filling to form a food product.

10. The flatbread food product of claim 9 wherein the striped shell is a striped tortilla shell.

11. The flatbread food product of claim 9 wherein the food product is an elongated food product and at least one stripe of the striped shell is positioned at an angle with respect to a longitudinal axis of the elongated food product.

12. The flatbread food product of claim 9 wherein the striped shell comprises a substantially planar base portion and at least one stripe formed across the substantially planar base portion, wherein the stripe comprises a different flavor than the substantially planar base portion.

13. The flatbread food product of claim 9 wherein the food product is a fried taquito.

14. A method of producing a tortilla comprising:
loading a first dough material into a primary dough extruder;
loading a second dough material into a secondary dough extruder, the second dough material having one of a color or a flavor different from the first dough material;
extruding the first dough material from the primary dough extruder onto a conveyor belt in the form of a sheet of dough, wherein the conveyor belt advances the sheet of dough to the secondary dough extruder;
extruding the second dough material from the secondary dough extruder onto the sheet of dough in the form of bands;
pressing the bands into the sheet of dough to form a striped sheet of dough; and
advancing the striped sheet of dough through a cutter die to form striped tortilla shells.

15. The method of claim 14 wherein the conveyor belt moves the sheet of dough beneath the secondary dough extruder such that the bands extend parallel to one another along the sheet of dough.

16. The method of claim 14 wherein the bands are pressed through less than an entire thickness of the sheet of dough such that the stripes do not extend through the entire thickness.

17. The method of claim 14 further comprising:
advancing the round tortilla shells through an oven to cook the tortilla shells.

18. The method of claim 14 wherein the second dough material comprises a coloring or a flavoring different from the first dough material.

19. The method of claim 14 wherein the bands are pressed into a first side of the sheet of dough, the method further comprising:
pressing one or more bands into a second side of the sheet of dough material such that the striped tortilla shells have stripes on both sides.

20. The method of claim 14 further comprising:
rolling the striped tortilla shells around a filling to form an edible food product.
